(19) United States
(12) Patent Application Publication
(10) Pub. No.: US 2022/0037687 A1
(43) Pub. Date: Feb. 3, 2022

(54) FUEL CELL SYSTEM AND METHOD OF CONTROLLING FUEL CELL SYSTEM

(71) Applicant: TOYOTA JIDOSHA KABUSHIKI KAISHA, Toyota-shi (JP)

(72) Inventor: Takanori NAKANO, Okazaki-shi (JP)

(73) Assignee: TOYOTA JIDOSHA KABUSHIKI KAISHA, Toyota-shi (JP)

(21) Appl. No.: 17/443,822

(22) Filed: Jul. 27, 2021

(30) Foreign Application Priority Data
Jul. 29, 2020 (JP) 2020-127874

(51) Int. Cl. H01M 8/04119; H01M 8/04082; H01M 8/0438

(52) U.S. Cl. CPC H01M 8/04164; H01M 8/04388; H01M 8/04201

(57) ABSTRACT

A fuel cell system includes: a fuel cell with an anode supply port and an anode discharge port; an anode supply pipe connected to the anode supply port; a fuel gas supplier provided in the anode supply pipe; an anode circulation pipe connecting the anode discharge port and the anode supply pipe at a position between the fuel gas supplier and the anode supply port to each other; a pressure sensor that detects an internal pressure in the anode supply pipe at the position between the fuel gas supplier and the anode supply port; a circulation pump provided in the anode circulation pipe; and a controller that controls the circulation pump. In at least one of a condition where an internal pressure in the anode supply pipe acquired from the pressure sensor meets a value equal to or greater than a first pressure value and a condition where a variation of the internal. pressure meets a value equal to or greater than a first variation, the controller feeds a fuel gas in a direction from the anode supply pipe toward the anode discharge port by controlling the circulation pump.

### CROSS-REFERENCE TO RELATED APPLICATIONS

This application claims priority from Japanese patent application JP2020-127874 filed on Jul. 29, 2020, the disclosure of which is hereby incorporated in its entirety by reference into this application.

### BACKGROUND

### Field

This disclosure relates to a fuel cell system and a method of controlling a fuel cell system.

### Related Art

In one disclosed fuel cell system, a relief valve is provided in a fuel gas flow path for supply of a fuel gas to a fuel cell (Japanese Patent Application Publication No. 2005-332648, for example). To prevent the pressure of the fuel gas in the fuel gas flow path from increasing to such a degree as to damage each part of the fuel cell system, the relief valve is used for releasing the fuel gas to the outside if the pressure in the fuel gas flow path becomes equal to or greater than a predetermined pressure.

There has been a need for a technique of suppressing increase in an internal pressure in a fuel gas flow path for preventing damage on each part of a fuel cell system without causing increase in a parts count arranged in the fuel gas flow path.

### SUMMARY

(1) According to one aspect of this disclosure, a fuel cell system is provided. The fuel cell system includes: a fuel cell having an anode supply port and an anode discharge port; an anode supply pipe connected to the anode supply port; a fuel gas supplier arranged at the anode supply pipe, the fuel gas supplier configured to adjust a supply quantity of a fuel gas to be supplied to the fuel cell; an anode circulation pipe connected to the anode discharge port and a position at the anode supply pipe, the position at the anode supply pipe arranged between the fuel gas supplier and the anode supply port; a pressure sensor configured to detect an internal pressure in the anode supply pipe between the fuel gas supplier and the anode supply port; a circulation pump arranged at the anode circulation pipe; and a controller configured to control the circulation pump. In a condition where the internal pressure in the anode supply pipe meets a value equal to or greater than a predetermined first pressure value and/or a condition where a variation of the internal pressure meets a value equal to or greater than a predetermined first variation, the controller may control the circulation pump to feed the fuel gas from the anode supply pipe toward the anode discharge port.

The fuel cell system of this aspect achieves reduction in the internal pressure in the anode supply pipe without providing a relief valve. This makes it possible to suppress increase in the internal pressure in the anode supply pipe in order to prevent damage on each part of the fuel cell system without causing increase in a parts count in the fuel cell system.

### BRIEF DESCRIPTION OF THE DRAWINGS

FIG. 1. is an explanatory view showing the configuration of a fuel cell system of a first embodiment;

FIG. 2 is a flowchart showing feed direction changing control performed using a circulation pump by the fuel cell system of the first embodiment;

FIG. 3 is a timing chart showing an example of the feed direction changing control performed using the circulation pump if a first condition is fulfilled;

FIG. 4 is a timing chart showing an example of the feed direction changing control performed using the circulation pump if a second condition is fulfilled;

FIG. 5 is a timing chart showing an example of the feed direction changing control performed using the circulation pump if a third condition is fulfilled; and

FIG. 6 is a flowchart showing feed direction changing control performed using a circulation pump by a fuel cell system of a second embodiment.

### DETAILED DESCRIPTION

### A. First Embodiment

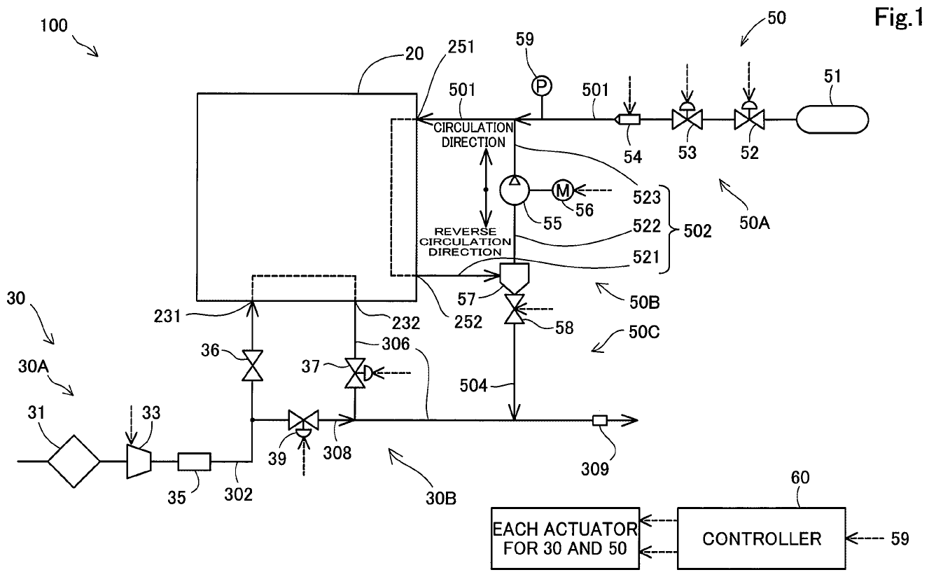

FIG. 1 is an explanatory view showing the configuration of a fuel cell system 100 of a first embodiment. The fuel cell system 100 is mounted on a fuel cell vehicle using a fuel cell 20 as a driving source, for example. The fuel cell system 100 drives various types of devices included in a load using power generated by the fuel cell 20. The fuel cell system 100 includes the fuel cell 20, a controller 60, an oxidizing gas supply/discharge system 30, and a fuel gas supply/discharge system 50. The fuel cell system 100 may further include a coolant circulation system that circulates a coolant through the fuel cell 20 to adjust the temperature of the fuel cell 20, and may further include a secondary cell to function together with the fuel cell 20 as a power source for the load.

The fuel cell 20 has a stack structure with a plurality of single fuel cells each having a membrane electrode assembly (MEA) in which electrodes including an anode and a cathode are bonded to the both sides of an electrolyte membrane. The fuel cell 20 is a solid polymer fuel cell that generates power in response to supply of hydrogen gas and air as reactive gases. The generated power is used for driving the load. The load includes a drive motor for generating driving power for a fuel cell vehicle, a heater used for air conditioning in the fuel cell vehicle, etc., for example. The fuel cell 20 includes an anode supply port 251 for supply of hydrogen gas as a fuel gas to the anode, an anode discharge port 252 for discharge of the hydrogen gas from the anode, a cathode supply port 231 for supply of air as an oxidizing gas to the cathode, and a cathode discharge port 232 for discharge of the air from the cathode. The fuel cell 20 is not limited to a solid polymer fuel cell but it may also be any type of fuel cell such as a phosphoric-acid fuel cell, a molten carbonate fuel cell, a solid oxide fuel cell, etc. The fuel cell system 100 may be used as a household power supply or for stationary power generation, in addition to the use in the fuel cell vehicle.

The controller 60 is composed of a microcomputer including a microprocessor to perform logic operation, and a memory such as a ROM or a RAM, for example. In response to execution of a program stored in the memory by the microprocessor, the controller 60 performs various types of control over the fuel cell system 100 including control over power generation by the fuel cell 20 and feed direction changing control using a circulation pump 55 described later.

The oxidizing gas supply/discharge system 30 includes an oxidizing gas supply system 30A having a cathode gas supply function, and an oxidizing gas discharge system 30B having a cathode gas discharge function and a cathode gas bypass function. The cathode gas supply function means a function of supplying air containing oxygen as a cathode gas to the cathode of the fuel cell 20. The cathode gas discharge function means a function of discharging a cathode off-gas that is a discharge gas discharged from the cathode of the fuel cell 20 to the outside, The cathode gas bypass function means a function of discharging part of the cathode gas to be supplied to the outside without supplying this part of the cathode gas to the fuel cell 20.

The oxidizing gas supply system 30A has the cathode gas supply function and supplies air as the cathode gas to the cathode of the fuel cell 20. The oxidizing gas supply system 30A includes a cathode supply pipe 302, an air cleaner 31, an air compressor 33, an intercooler, 35, and an inlet valve 36.

The cathode supply pipe 302 is connected to the cathode supply port 231 of the fuel cell 20 and functions as an air supply flow path for the cathode of the fuel cell 20. The air cleaner 31 is provided in the cathode supply pipe 302 at a position closer to an air inlet port than the air compressor 33, namely, upstream from the air compressor 33. The air cleaner 31 removes foreign substances in air to be supplied to the fuel cell 20.

The air compressor 33 is provided in the cathode supply pipe 302 at a position between the air cleaner 31 and the fuel cell 20. The air compressor 33 functions as a cathode gas supplier that compresses air taken in through the air cleaner 31 and feeds the compressed air to the cathode. For example, a turbocompressor is used as the air compressor 33. The air compressor 33 is driven under control by the controller 60. The controller 60 controls the number of rotations of the air compressor 33 to adjust the amount of air to be fed downstream. The controller 60 causes the air compressor 33, a bypass valve 39, and an outlet valve 37 to work cooperatively to adjust the flow rate of air to flow in the fuel cell 20 and the flow rate of air to be discharged through a cathode discharge pipe 306.

The intercooler 35 is provided in the cathode supply pipe 302 at a position between the air compressor 33 and the cathode supply port 231. The intercooler 35 cools the cathode gas increased to a high temperature by being compressed by the air compressor 33. The inlet valve 36 is an on/off valve to be opened mechanically by incoming flow of the cathode gas at a pressure determined in advance. The inlet valve 36 is used for controlling flow of the cathode gas into the cathode of the fuel cell 20.

The oxidizing gas discharge system 30B has a cathode off-gas discharge function and includes the cathode discharge pipe 306, a bypass pipe 308, the bypass valve 39, the outlet valve 37, and a discharge gas discharge port 309. The cathode discharge pipe 306 is a cathode off-gas discharge flow path having one end connected to the cathode discharge port 232 of the fuel cell 20. The cathode discharge pipe 306 is used for guiding a discharge gas from the fuel cell 20 containing the cathode off-gas to the discharge gas discharge port 309 corresponding to the other end of the cathode discharge pipe 306, and discharging the guided gas to the atmosphere. The discharge gas discharged into the atmosphere from the cathode discharge pipe 306 contains an anode off-gas from an anode discharge pipe 504 and air flowing out from the bypass pipe 308, in addition to the cathode off-gas.

The outlet valve 37 is provided in the cathode discharge pipe 306 at a position near the cathode discharge port 232. More specifically, the outlet valve 37 is arranged in the cathode discharge pipe 306 at a position closer to the fuel cell 20 than a position of connection between the cathode discharge pipe 306 and the bypass pipe 308. For example, a solenoid valve or an electric-operated valve is usable as the outlet valve 37. The controller (30 adjusts the amount of opening of the outlet valve 37 to adjust a back pressure at the cathode of the fuel cell 20.

The bypass pipe 308 is a pipe line connecting the cathode supply pipe 302 and the cathode discharge pipe 306 to each other without passing through the fuel cell 20. The bypass valve 39 is provided in the bypass pipe 308. For example, a solenoid valve or an electric-operated valve is usable as the bypass valve 39. Opening the bypass valve 39 causes at least part of the cathode gas flowing in the cathode supply pipe 302 to enter the cathode discharge pipe 306. The controller 60 adjusts the amount of opening of the bypass valve 39 to adjust the flow rate of the cathode gas to flow into the bypass pipe 308, thereby adjusting the discharge amount of air to flow through the cathode discharge pipe 306 and then to be discharged from the discharge gas discharge port 309.

The fuel gas supply/discharge system 50 includes a fuel gas supply system 50A having an anode gas supply function, a fuel gas discharge system 50C having an anode gas discharge function, and a fuel gas circulation system 50B having an anode gas circulation function. The anode gas supply function means a function of supplying an anode gas containing a fuel gas to the anode of the fuel cell 20. The anode gas discharge function means a function of discharging an anode off-gas that is a discharge gas discharged from the anode of the fuel cell 20 to the outside. The anode gas circulation function means a function of circulating hydrogen contained in the anode off-gas inside the fuel cell system 100.

The fuel gas supply system 50A supplies hydrogen as the anode gas to the anode of the fuel cell 20. The fuel gas supply system 50A includes an anode supply pipe 501, a fuel gas tank 51, an on/off valve 52, a regulator 53, an injector 54, and a pressure sensor 59.

The anode supply pipe 501 connects the fuel gas tank 51 as a hydrogen source and the anode supply port 251 of the fuel cell 20 to each other. The anode supply pipe 501 is used for guiding the anode gas to the anode of the fuel cell 20. The on/off valve 52 is provided in the anode supply pipe 501 at a position near the exit of the fuel gas tank 51. The on/off valve 52 is also called a main stop valve. The on/off valve 52 in an opened state is used for distributing hydrogen downstream from the fuel gas tank 51. The regulator 53 is a pressure reducing valve and provided in the anode supply pipe 501 at a position downstream from the on/off valve 52, which is a position closer to the fuel cell 20. The regulator 53 adjusts the pressure of hydrogen in a place upstream from the injector 54 under control by the controller 60. The controller 60 stops downstream supply of hydrogen by closing the valve of the regulator 53.

The injector 54 is provided in the anode supply pipe 501 at a position downstream from the regulator 53. The injector 54 is an on/off valve controlled by the controller 60 and to be driven electromagnetically in response to a set driving cycle or valve open time. The injector 54 functions as a fuel gas supplier that adjusts the amount of supply of the anode gas to be supplied to the fuel cell 20. The injector 54 may be subjected to abnormality of failing to closing a solenoid valve at least temporarily inside the injector 54 to be caused by mixture with incoming foreign substances, for example (such abnormality may also be called “opening abnormality”). The occurrence of the opening abnormality at the injector 54 may cause the anode gas to be supplied continuously to the fuel cell 20, for example, and this may cause trouble of increasing an internal pressure in the anode supply pipe 501 continuously. On the occurrence of the opening abnormality at the injector 54, an internal pressure in the anode supply pipe 501 may possibly he increased to such a degree as to damage each part of the fuel cell system 100.

The pressure sensor 59 is provided in the anode supply pipe 501 at a position between the injector 54 and the anode supply port 251. The pressure sensor 59 acquires an internal pressure in the anode supply pipe 501 at a position downstream from the injector 54 and outputs the acquired internal pressure to the controller 60. The pressure sensor 59 may be provided in a third circulation pipe 523.

The fuel gas circulation system 50B separates the anode off-gas discharged from the anode of the fuel cell 20 into a gas component and a liquid component, and then causes the components to circulate through the anode supply pipe 501. The fuel gas circulation system 50B includes an anode circulation pipe 502, a gas-liquid separator 57, and the circulation pump 55.

The anode circulation pipe 502 is used for guiding the anode off-gas discharged from the anode to the anode supply pipe 501. The anode circulation pipe 502 has one end connected to the anode discharge port 252 of the fuel cell 20, and the other end connected to the anode supply pipe 501 at a position between the injector 54 and the anode supply port 251. The gas-liquid separator 57 and the circulation pump 55 are provided in the anode circulation pipe 502. A pipe line forming the anode circulation pipe 502 and extending from the anode discharge port 252 to the gas-liquid separator 57 is also called a “first circulation pipe 521,” a pipe line forming the anode circulation pipe 502 and extending from the gas-liquid separator 57 to the circulation pump 55 is also called a “second circulation pipe 522,” and a pipe line forming the anode circulation pipe 502 and extending from the circulation pump 55 to the anode supply pipe 501 is also called a “third circulation pipe 523.” In response to downstream supply of hydrogen from the injector 54, internal pressures are increased in the anode supply pipe 501, in the anode of the fuel cell 20, and in the anode circulation pipe 502. The internal pressures in the anode supply pipe 501, in the anode of the fuel cell 20, and in the anode circulation pipe 502 become lower at a further downstream position. More specifically, the internal pressures become lower in the following order: in the anode supply pipe 501 and the third circulation pipe 523, in the anode of the fuel cell 20, in the first circulation pipe 521, and in the second circulation pipe 522. To make the internal pressures in the first circulation pipe 521 and the second circulation pipe 522 sufficiently less than the internal pressure in the anode supply pipe 501, each of the first circulation pipe 521 and second circulation pipe 522 preferably has the largest possible volume in the pipe line.

The gas-liquid separator 57 is provided in the anode circulation pipe 502, separates the anode off-gas containing water vapor into a gas component and a liquid component, and then stores the liquid component. The gas-liquid separator 57 is arranged in the anode circulation pipe 502 at a position between the circulation pump 55 and the anode discharge port 252.

The circulation pump 55 is arranged in the anode circulation pipe 502 at a position between the gas-liquid separator 57 and the anode supply pipe 501. The circulation pump 55 includes a motor 56 driven under control by the controller 60. By driving the motor 56 to rotate in a forward direction, the circulation pump 55 feeds the anode off-gas having flowed into the second circulation pipe 522 in a circulation direction from the anode discharge port 252 toward the anode supply pipe 501. In the first embodiment, as the controller 60 drives the motor 56 to rotate in a reverse direction, the circulation pump 55 feeds hydrogen in the anode supply pipe 501 in a direction from the anode supply pipe 501 toward the anode discharge port 252 (this direction is also called a “reverse circulation direction”). This allows hydrogen in the anode supply pipe 501 in a place downstream from the injector 54 to be fed to the second circulation pipe 522 and the third circulation pipe 523. If the motor 56 is a three-phase induction motor, for example, the rotation direction of the circulation pump 55 is switched by changing order in which a current is to flow in coils of two phases. A direction of gas feeding using the circulation pump 55 may be switched by switching an installation direction of the circulation pump 55 or switching a flow path in the circulation pump 55, in addition to using the rotation direction of the motor 56. Control using the circulation pump 55 for feeding gas in the circulation direction is also called a “normal mode,” and control using the circulation pump 55 for feeding the gas in the reverse circulation direction is also called a “reverse rotation mode.”

The fuel gas discharge system 50C discharges the anode off-gas or liquid water stored in the gas-liquid separator 57 to the outside. The fuel gas discharge system 50C includes the anode discharge pipe 504 and an exhaust/drain valve 58. The anode discharge pipe 504 has one end connected to the anode circulation pipe 502 at a position between the circulation pump 55 and the anode discharge port 252. In the first embodiment, the one end of the anode discharge pipe 504 is connected to a discharge port of the gas-liquid separator 57. The anode discharge pipe 504 has the other end connected to the cathode discharge pipe 306 at a position between the cathode discharge port 232 and the discharge gas discharge port 309. The anode discharge pipe 504 is used for draining water from the gas-liquid separator 57 and discharging part of the anode off-gas passing through the gas-liquid separator 57 from the fuel gas supply/discharge system 50. The other end of the anode discharge pipe 504 may be opened to the outside as a discharge port to the atmosphere without being connected to the cathode discharge pipe 306.

The exhaust/drain valve 58 is provided in the anode discharge pipe 504 and used for opening and closing a flow path in the anode discharge pipe 504. For example, a diaphragm valve is usable as the exhaust/drain valve 58. The exhaust/drain valve 58 is opened and closed under control by the controller 60. In the first embodiment, when the exhaust/drain valve 58 is opened, the liquid water and the anode off-gas stored in the gas-liquid separator 57 are discharged to the atmosphere through the cathode discharge pipe 306. The exhaust/drain valve 58 may be replaced by an exhaust valve and a drain valve provided separately.

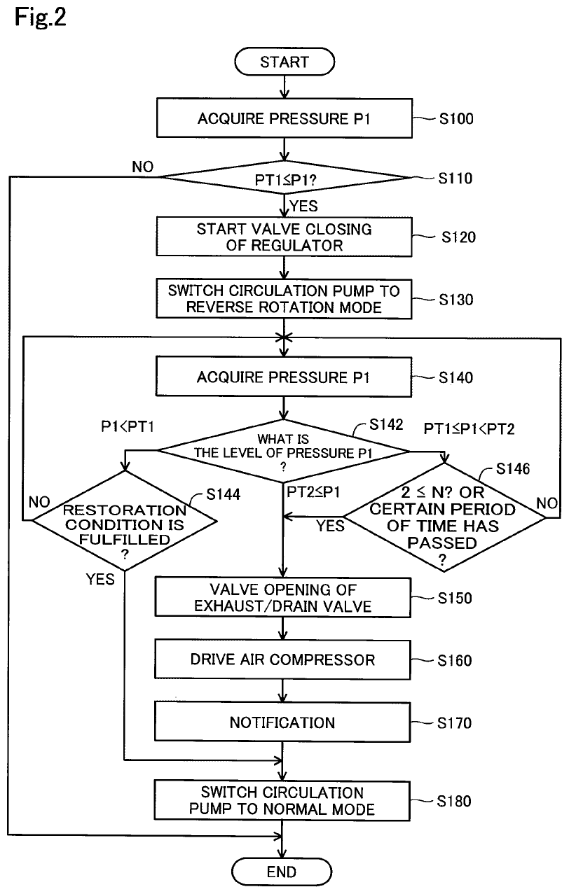

FIG. 2 is a flowchart showing the feed direction changing control performed using the circulation pump 55 by the controller 60 in the fuel cell system 100 of the first embodiment. This flow is started by the start of the operation of the fuel cell system 100, for example. This flow may be performed repeatedly at periods determined in advance such as every few milliseconds, for example.

In step S100, the controller 60 acquires a pressure P1 corresponding to an internal pressure in the anode supply pipe 501 from the pressure sensor 59. In step S110, the controller 60 compares the acquired pressure P1 and a first pressure value PT1 determined in advance. The first pressure value PT1 is a threshold for detecting abnormality of the pressure P1 in a high pressure level and is freely settable. The first pressure value PT1 is settable using an upper limit value defined in a process management standard for the pressure P1, for example. The first pressure value PT1 is preferably set at a pressure value greater than a pressure in normal times, which is high enough to allow detection of abnormality of the pressure P1 in a high pressure level. In terms of realizing early detection of abnormality, the first pressure value PT1 is preferably set at a pressure value sufficiently less than a pressure to damage each part of the fuel cell system 100. If the pressure P1 is less than the first pressure value PT1 (S110: NO), this flow is finished.

If the pressure P1 shows a value equal to or greater than the first pressure value PT1 (S110: YES), the controller 60 starts to control valve closing of the regulator 53 (step S120). The pressure P1 is assumed to show a value equal to or greater than the first pressure value PTI on the occurrence of the opening abnormality at the injector 54, for example. When the controller 60 transmits a control signal about the valve closing control to the regulator 53, the regulator 53 starts to close the valve and completes the valve closing in response to passage of a certain period of time. When the valve closing of the regulator 53 is completed, supply of hydrogen to the injector 54 is stopped to stop increase in the pressure P1. The controller 60 may judge whether the opening abnormality is present at the injector 54 before implementation of step S120, and then perform step S120 if the presence of the opening abnormality is judged.

In step S130, the controller 60 switches the circulation pump 55 to the reverse rotation mode. More specifically, the controller 60 rotates the motor 56 of the circulation pump 55 reversely to switch a direction of hydrogen feeding using the circulation pump 55 from the circulation direction to the reverse circulation direction. By doing so, hydrogen is distributed from the anode supply pipe 501 to the second circulation pipe 522. In step S130, the controller 60 may adjust the number of rotations of the circulation pump 55 in the reverse rotation mode using the pressure P1 detected in step S110, for example. The fuel cell system 100 having the foregoing configuration achieves reduction in power consumption at the circulation pump 55 to allow the pressure P1 to be reduced efficiently.

In step S140, the controller 60 acquires the pressure P1 from the pressure sensor 59. In step S142, the controller 60 compares the pressure P1 with the first pressure value PT1 and a second pressure value PT2. The second pressure value PT2 is a threshold for detecting abnormality of the pressure P1 in a still higher pressure level than the first pressure value PT1, and is freely settable using a value greater than the first pressure value PT1. The second pressure value PT2 is preferably set by giving consideration to time required for the controller 60 to perform control after the detection. In order to avoid damage on each part of the fuel cell system 100, the second pressure value PT2 is preferably set at a pressure value less than a withstand pressure at each part of the fuel cell system 100.

If the pressure P1 is less than the first pressure value PT1 (S142: P1<PT1), the controller 60 determines whether a restoration condition is fulfilled (step S144). The “restoration condition” means a condition to determine whether abnormality of the pressure P1 in a high pressure level is resolved. For example, the restoration condition is settable using at least any of the following conditions (1) to (3):

Condition (1): Define that a certain period of time has passed since abnormality of the pressure P1 was determined in step S110. Specifically, the condition (1) is to determine that the pressure P1 is not increased again to the first pressure value PT1 at a point in time when the certain period of time has passed since the pressure P1 showed a value equal to or greater than the first pressure value PT1 in step S110.

Condition (2): Define that a variation of the pressure P1 shows negative variation of a degree with which the pressure P1 is expected to restore its normal value.

Condition (3): Define that a factor for increasing the pressure P1 such as the opening abnormality at the injector 54 is removed.

In the first embodiment, the condition (1) is set as the restoration condition in order to make a judgment in step S146 as to the fulfillment of a third condition defining that the pressure P1 increases again to show a value equal to or greater than the first pressure value PT1 even after the pressure P1 falls under the first pressure value PT1 in step S140. The certain period of time defined in the condition (1) is freely settable using a period of time sufficient for determining that the pressure P1 has been stabilized. For example, the certain period of time defined in the condition (1) is settable using a period of time from output of a control signal to the regulator 53 for starting valve closing from the controller 60 until completion of the valve closing of the regulator 53, for example.

If the restoration condition is fulfilled (S144: YES), the controller 60 goes to step S180 in which the controller 60 controls the circulation pump 55 to make a switch from the reverse rotation mode to the normal mode. If the restoration condition is not fulfilled (S144: NO), the controller 60 increments a count N by one indicating the number of times step S144 has been passed through, and then repeats steps S140 and S142 to continue monitoring of the pressure P1.

If the pressure P1 is determined to he equal to or greater than the first pressure value PT1 and less than the second pressure value PT2 in step S142 (S142: PT1≤P1<PT2), the controller 60 determines whether the count N indicating the number of times step S144 has been passed through is equal to or greater than two, and whether a period of time having passed since abnormality of the pressure P1 was detected in step S110 exceeds a period of time determined in advance (step S146). If N shows a value equal to or greater than two (S146: YES), the third condition is fulfilled. and the flow goes to step S150. The third condition is assumed to be fulfilled in a case where, after the pressure P1 is reduced by applying the reverse rotation mode of the circulation pump 55, internal pressures in the second circulation pipe 522 and the third circulation pipe 523 are increased by amounts exceeding the amount of reduction in the pressure P1 using the circulation pump 55 to increase the pressure P1 again to the first pressure value PTI1, for example. In step S146, in addition to a judgment as to the fulfillment of the third condition, the fulfillment of a second condition is judged. The second condition defines that the pressure P1 shows a value equal to or greater than the first pressure value PTI at a point in time when the period of time determined in advance has passed since abnormality of the pressure P1 was detected in step S110. The second condition is assumed to be fulfilled in a case where the amount of reduction in the pressure P1 resulting from the application of the reverse rotation mode of the circulation pump 55 and the amount of increase in the pressure P1 resulting from supply of hydrogen from the injector 54 are balanced so the pressure P1 is placed in a stable state in which the pressure P1 is equal to or greater than the first pressure value PTI and less than the second pressure value PT2, for example. The certain period of time determined in step S146 is freely settable using a period of time in which the pressure P1 is brought to a substantially stable state. For example, this period of time is settable using a period of time from transmission of a control signal to the regulator 53 for starting valve closing from the controller 60 until completion of the valve closing of the regulator 53. If N less than two and the certain period of time has not passed (S146: NO), the controller 60 repeats steps S140 and S142 to continue monitoring of the pressure P1. If the count N is less than two and the certain period of time has passed (S146: YES), the controller 60 goes to step S150. Instead of performing step S150, the controller 60 may go to step S170 in which the controller 60 makes a notification of abnormality indicating that the pressure P1 is equal to or greater than the first pressure value PT1. In step S146, instead of determining the passage of the certain period of time, completion of the valve closing of the injector 54 may be determined.

If a first condition defining that the pressure P1 shows a value equal to or greater than the second pressure value PT2 is fulfilled in step S142 (S142:PT2≤P1), the controller 60 controls valve opening of the exhaust/drain valve 58 (step S150). The first condition is assumed to be fulfilled in a case where the pressure P1 increases with a high gradient so it may possibly reach a pressure to damage each part of the fuel cell system 100, for example. In step S150, exhausting hydrogen from the anode circulation pipe 502 is sufficient. Thus, instead of the control over the exhaust/drain valve 58, valve opening of the exhaust valve may be controlled to exhaust hydrogen from the anode circulation pipe 502. In step S150, the liquid water stored in the gas-liquid separator 57 is not required to be drained. The controller 60 may adjust the number of rotations of the circulation pump 55 in the reverse rotation mode using the pressure P1 detected in step S142, for example. The fuel cell system 100 having the foregoing configuration achieves reduction in power consumption at the circulation pump 55 to allow the pressure P1 to be reduced efficiently.

In step S160, the controller 60 controls driving of the air compressor 33 to increase the amount of supply of air to an amount greater than an amount during normal operation. More specifically, the controller 60 increases the number of rotations of the air compressor 33 to achieve a greater amount of supply of air than that during the normal operation. Increasing the amount of supply of air using the controller 60 increases the amount of air to be discharged from the cathode discharge pipe 306. In addition to controlling the amount of rotation of the air compressor 33, the controller 60 may adjust the amount of opening of the bypass valve 39 or the amount of opening of the outlet valve 37 to increase the amount of supply and the amount of discharge of air. The controller 60 may adjust the amount of discharge of air not only by adjusting the amount of supply of air to be supplied to the fuel cell 20 but also by adjusting the amount of supply of air to be distributed through the bypass pipe 308.

In step S170, the controller 60 gives a notification of abnormality indicating that the pressure P1 is high to a user or an administrator of the fuel cell system 100, or a driver or an administrator of a fuel cell vehicle on which the fuel cell system 100 is mounted, for example. The controller 60 may make a notification of the opening abnormality at the injector 54, instead of or in addition to the abnormality of the pressure P1. In step S180, the controller 60 switches the circulation pump 55 from the reverse rotation mode to the normal mode and completes the process in this flow.

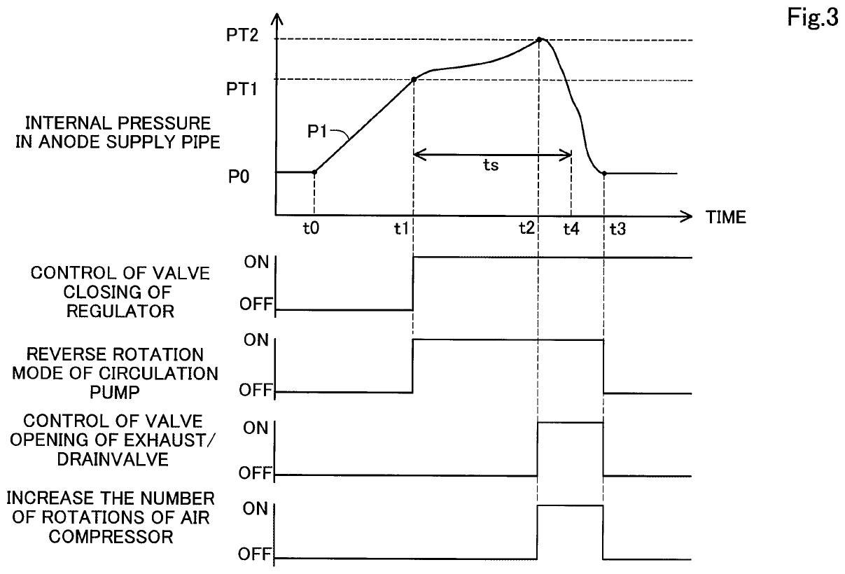

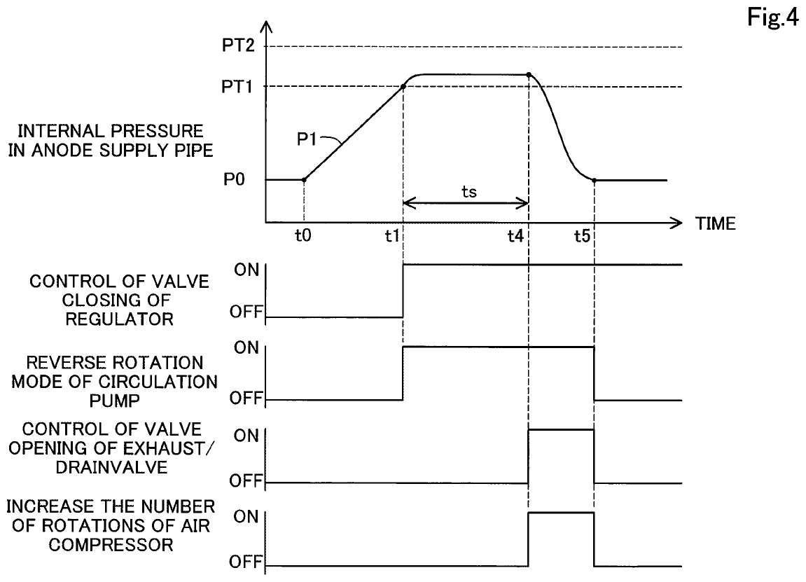

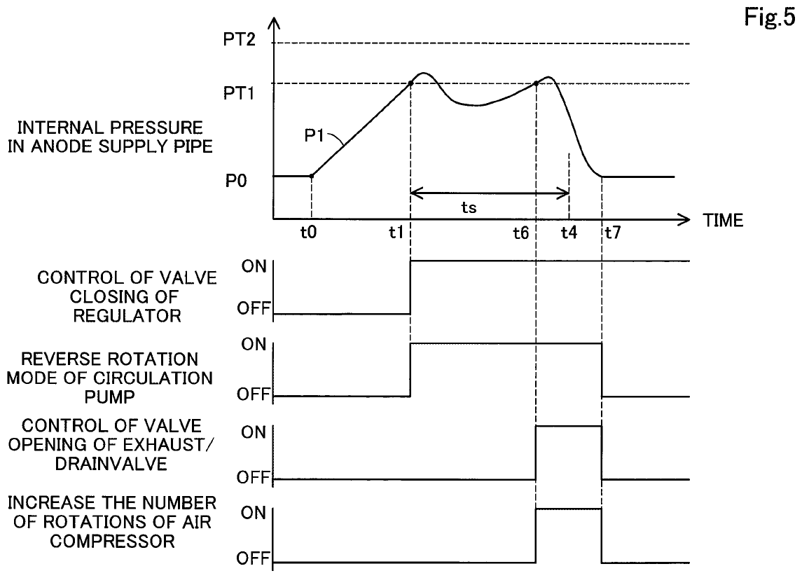

FIG. 3 is a timing chart showing an example of the feed direction changing control performed using the circulation pump 55 if the first condition is fulfilled. The top section of FIG. 3 shows exemplary change in the pressure P1 with respect to time. The lower sections show on/off of control of valve closing of the regulator 53, on/off of the reverse rotation mode of the circulation pump 55, on/off of control of valve opening of the exhaust/drain valve 58, and on/off of control of increasing the number of rotations of the air compressor 33. Time axes applied to the respective items in FIG. 3 are common to each other. The items shown in FIG. 3 are common to those in FIGS. 4 and 5.

At time t0, in response to the occurrence of the opening abnormality at the injector 54, for example, the pressure P1 increases from an initial value P0 and shows a value equal to or greater than the first pressure value PT1 at time t1. At the time t1, the controller 60 detects the pressure P1 equal to or greater than the first pressure value PT1, and controls valve closing of the regulator 53 and switches the circulation pump 55 from the normal mode to the reverse rotation mode. As a result of the switching of the circulation pump 55 to the reverse rotation mode, hydrogen in the anode supply pipe 501 is fed to the second circulation pipe 522 and the third circulation pipe 523. For this reason, after the time t1, the pressure P1 increases at a lower rate than a rate of increase in an interval from the time t0 to the time t1.

In the example of FIG. 3, the pressure P1 continues increasing after the time t1. The pressure P1 shows a value equal to or greater than the second pressure value PT2 at time t2 to fulfill the first condition. The controller 60 controls valve opening of the exhaust/drain valve 58 and performs control of increasing the number of rotations of the air compressor 33. As a result of the control of valve opening of the exhaust/drain valve 58, internal pressures are reduced in the anode supply pipe 501, in the anode circulation pipe 502, and in the anode of the fuel cell 20. Time t4 shown in FIGS. 3, 4, and 5 means a point in time when a period of time ts determined in advance has passed since the time t1.

FIG. 4 is a timing chart showing an example of the feed direction changing control performed using the circulation pump 55 if the second condition is fulfilled. Like in FIG. 3, the controller 60 controls valve closing of the regulator 53 and switches the circulation pump 55 from the normal mode to the reverse rotation mode at the time t1. If increase in the pressure P1 in the anode supply pipe 501 resulting from hydrogen supply from the injector 54 and pressure reduction resulting from the reverse rotation mode of the circulation pump 55 occur to substantially equal degrees, for example, the pressure P1 takes a constant pressure value after exceeding the first pressure value PT1. At the time t4 when the period of time ts determined in advance has passed, the pressure P1 shows a value equal to or greater than the first pressure value PT1, thereby fulfilling the second condition. The controller 60 controls valve opening of the exhaust/drain valve 58 and performs control of increasing the number of rotations of the air compressor 33 at the time t4.

FIG. 5 is a timing chart showing an example of the feed direction changing control performed using the circulation pump 55 if the third condition is fulfilled. Like in FIGS. 3 and 4, the controller 60 controls valve closing of the regulator 53 and switches the circulation pump 55 from the normal mode to the reverse rotation mode at the time t1. After the pressure P1 shows a value equal to or greater than the first pressure value PT1 at the time t1, the pressure P1 reduces to show a pressure less than the first pressure value PT1. As the period of time ts determined in advance has not passed, the controller 60 increments the count N by one indicating the number of times step S144 has been passed through and continues monitoring of the pressure P1. The pressure P1 increases again to show a value equal to or greater than the first pressure value PT1 again at time t6 before passing of the period of time ts determined in advance, thereby fulfilling the third condition. The controller 60 controls valve opening of the exhaust/drain valve 58 and performs control of increasing the number of rotations of the air compressor 33 at the time t6. If the pressure P1 reduces after the time t1 to show a value less than the first pressure value PT1 and if the period of time ts has passed with the pressure P1 kept in this state, the restoration condition is fulfilled. Thus, the controller 60 switches the circulation pump 55 to the normal mode. This case is assumed to occur if the opening abnormality at the injector 54 is removed after the pressure P1 shows a value equal to or greater than the first pressure value PT1.

As described above, according to the fuel cell system 100 of the first embodiment, if the pressure P1 in the anode supply pipe 501 acquired from the pressure sensor 59 meets a value equal to or greater than the first pressure value PT1 determined in advance, the controller 60 performs the feed direction changing control using the circulation pump 55 to feed hydrogen in the reverse circulation direction from the anode supply pipe 501 toward the anode discharge port 252. This achieves reduction in the pressure P1 in the anode supply pipe 501 without providing a relief valve, making it possible to reduce the occurrence of a situation where the pressure P1 in the anode supply pipe 501 increases to such a degree as to damage each part of the fuel cell system 100 without causing increase in a parts count in the fuel cell system 100.

According to the fuel cell system 100 of the first embodiment, the controller 60 controls valve opening of the exhaust/drain valve 58 if at least one of the first condition, the second condition, and the third condition is fulfilled. The first condition defines that the pressure P1 shows a value equal to or greater than the second pressure value PT2 greater than the first pressure value PT1. The second condition defines that the pressure P1 shows a value equal to or greater than the first pressure value at a point in time when the period of time ts determined in advance has passed since the pressure P1 showed a value equal to or greater than the first pressure value PT1. The third condition defines that the pressure P1 increases again to show a value equal to or greater than the first pressure value PT1 after the pressure P1 falls under the first pressure value PT1. The valve opening of the exhaust/drain valve 58 is controlled to reduce the pressure P1 on condition that sufficiently reducing the pressure P1 is assumed to be impossible by the feed direction changing control using the circulation pump 55. This makes it possible to reduce or prevent unnecessary discharge of the anode gas.

According to the fuel cell system 100 of the first embodiment, if at least any of the first condition, the second condition, and the third condition is fulfilled, the controller 60 controls the air compressor 33 to increase the amount of supply of air to an amount greater than an amount during normal operation. Increasing the amount of discharge of air distributed through the cathode discharge pipe 306 allows reduction in concentration of the anode gas to flow into the cathode discharge pipe 306 through the anode discharge pipe 504. Thus, it becomes possible to reduce or prevent discharge of the anode gas of a high concentration to the outside from the fuel cell system 100.

### B. Second Embodiment

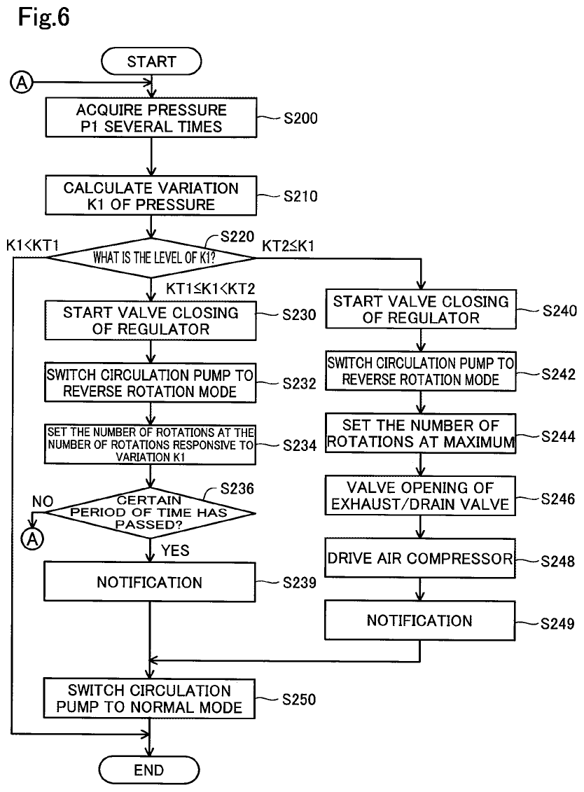

FIG. 6 is a flowchart showing feed direction changing control performed using the circulation pump 55 by a fuel cell system 100 of a second embodiment. The fuel cell system 100 of the second embodiment differs from the fuel cell system 100 of the first embodiment in that a variation K1 of the pressure P1 per unit time acquired from the pressure sensor 59 is used in making a judgment in the feed direction changing control using the circulation pump 55, and is the same in other respects as the fuel cell system 100 of the first embodiment.

In step S200 of FIG. 6, the controller 60 acquires the pressure P1 from the pressure sensor 59 several times in a period of time determined in advance. In step S210, the controller 60 calculates the variation K1 of the pressure P1 per unit time using the plurality of acquired pressures P1. The unit time used in step S210 is preferably set at such a period of time as to allow exclusion of detection error at the pressure sensor 59 or pressure fluctuation in the pressure P1 in normal times, which is preferably a period of time short enough to allow detection of a variation before the pressure P1 reaches the first pressure value PT1 or the second pressure value PT2 and allow implementation of the feed direction changing control using the circulation pump 55.

In step S220, the controller 60 compares the calculated variation K1 with a first variation KT1 and a second variation KT2 determined in advance. The first variation KT1 is a threshold for detecting abnormality occurring when the pressure P1 reaches the first pressure value PT1 and is freely settable. For example, the first variation. KT1 is settable using a variation that may possibly make the pressure P1 reach the first pressure value PT1 at a point in time when a period of time has passed from start of valve closing of the regulator 53 until completion of the valve closing thereof. The second variation KT2 is a threshold for detecting abnormality occurring when the pressure P1 reaches the second pressure value PT2 and is freely settable using a variation greater than the first variation KT1. For example, the second variation KT2 is settable using a variation that may possibly make the pressure P1 reach the second pressure value PT2 at a point in time when a period of time has passed until completion of valve closing of the regulator 53, even if the circulation pump 55 is driven in the reverse rotation mode of producing maximum output.

In step S220, if the calculated variation K1 is less than the first variation KT1 (S220: K1<KT1), this flow is finished. If the calculated variation K1 is equal to or greater than the first variation KT1 and less than the second variation KT2 (S220: KT1≤K1<KT2), the flow goes to step S230. If a fourth condition defining that the variation K1 shows a value equal to or greater than the second variation KT2 is fulfilled (S220: KT2≤K1), the flow goes to step S240.

In step S230, the controller 60 starts to control valve closing of the regulator 53. In step S232, the controller 60 switches the circulation pump 55 to the reverse rotation mode. In step S234, the controller 60 controls the motor 56 to set the number of rotations of the circulation pump 55 at the number of rotations thereof responsive to the variation K1 calculated in step S210. The “number of rotations responsive to the variation K1” means the number of rotations of the circulation pump 55 for reducing the variation K1 by such a degree as not to make the pressure P1 reach the first pressure value PT1. For example, this number of rotations corresponds to the number of rotations allowing the variation K1 calculated in step S210 to be reduced to zero or less if the circulation pump 55 is driven at this number of rotations in the reverse rotation mode.

In step S236, the controller 60 determines whether a period of time determined in advance has passed since abnormality of the variation K1 was detected in step S220. The certain period of time used in step S236 is settable using a period of time from output of a control signal for starting control of valve closing of the regulator 53 until completion of the valve closing of the regulator 53, for example. If the certain period of time has not passed (S236: NO), the flow returns to step S200 to continue monitoring of the pressure P1. If the certain period of time has passed (S236: YES), the flow goes to step S239 in which a notification indicating that the abnormality has occurred in the variation K1 of the pressure P1 or indicating the presence of the opening abnormality at the injector 54 is given to a user of the fuel cell system 100, for example. Then, the flow goes to step S250. In step S236, instead of making a determination as to the passing of the certain period of time, completion of the valve closing of the injector 54 may be determined.

In step S240, the controller 60 starts to control valve closing of the regulator 53. In step S242, the controller 60 switches the circulation pump 55 to the reverse rotation mode. In step S244, the controller 60 sets the number of rotations of the circulation pump 55 at the number of rotations thereof corresponding to maximum output in the reverse rotation mode. In step S246, the controller 60 controls valve opening of the exhaust/drain valve 58 to discharge hydrogen. In step S248, the controller 60 controls driving of the air compressor 33 to increase the number of rotations of the air compressor 33, thereby providing a greater amount of supply of air than that during normal operation. By doing so, the amount of air to be discharged from the cathode discharge pipe 306 is increased. In addition to controlling the amount of rotation of the air compressor 33, the controller 60 may adjust the amount of opening of the bypass valve 39 or the amount of opening of the outlet valve 37 to increase the amount of discharge of air.

In step S249, the controller 60 gives a notification indicating that the abnormality has occurred in the variation K1 of the pressure P1 to the user of the fuel cell system 100, for example. Alternatively, the controller 60 may make a notification indicating the opening abnormality at the injector 54. In step S250, the controller 60 switches the circulation pump 55 from the reverse rotation mode to the normal mode and completes this flow.

According to the fuel cell system 100 of the second embodiment, if the calculated variation K1 of the pressure P1 meets a value equal to or greater than the first variation KT1 determined in advance, the controller 60 performs the feed direction changing control using the circulation pump 55 to feed hydrogen in the reverse circulation direction from the anode supply pipe 501 toward the anode discharge port 252. Using the variation K1 of the pressure P1 in the feed direction changing control using the circulation pump 55 makes it possible to determine at an early stage that the pressure P1 may possibly reach the first pressure value PT1 or the second pressure value PT2. This achieves reduction in the occurrence of a situation at an early stage where the pressure P1 in the anode circulation pipe 502 increases to such a degree as to damage each part of the fuel cell system 100.

According to the fuel cell system 100 of the second embodiment, if the controller 60 uses the variation K1 of the pressure P1 to adjust the amount of rotation of the circulation pump 55 in the feed direction changing control using the circulation pump 55. Thus, this prevents output from the circulation pump 55 from unnecessarily increasing to reduce power consumption at the circulation pump 55, thereby allowing the pressure P1 to be reduced efficiently.

According to the fuel cell system 100 of the second embodiment, if the fourth condition defining that the variation K1 of the pressure P1 shows a value equal to or greater than the second variation KT2 greater than the first variation KT1 is fulfilled, valve opening of the exhaust/drain valve 58 is controlled. This realizes early estimation of a situation where reducing the pressure P1 sufficiently is assumed to be impossible by the feed direction changing control using the circulation pump 55, and the pressure P1 is reduced by controlling the valve opening of the exhaust/drain valve 58. Thus, this achieves reduction in load to be imposed on each part of the fuel cell system 100 by the increase in the pressure P1. Furthermore, starting discharge of the anode gas at an early stage makes it possible to further reduce or prevent discharge of the anode gas of a high concentration to the outside from the fuel cell system 100.

### C. Other Embodiments

(C1) In the above-described first embodiment, the controller 60 compares the pressure P1 acquired from the pressure sensor 59 with the first pressure value PT1 and the second pressure value PT2. In the above-described second embodiment, the controller 60 compares the variation K1 of a pressure with the first variation KT1 and the second variation KT2. By contrast, the controller 60 may compare the variation K1 with the first variation KT1 and the second variation KT2, in addition to comparing the pressure P1 with the first pressure value PT1 and the second pressure value PT2. In this case, in at least one of the situation where the pressure P1 meets a value equal to or greater than the first pressure value PT1 and a situation where the variation K1 of the pressure P1 meets a value equal to or greater than the first variation KT1, the controller 60 may perform the feed direction changing control using the circulation pump 55. Also, if at least one of the first condition, the second condition, the third condition, and the fourth condition is fulfilled, the controller 60 may control valve opening of the exhaust/drain valve 58 or perform control of increasing the amount of rotation of the air compressor 33.

This disclosure is not limited to the foregoing embodiments but is feasible in various configurations within a range not deviating from the substance of this disclosure. For example, technical features in the embodiments may be replaced or combined, where appropriate, with the intention of solving some or all of the aforementioned problems or achieving some or all of the aforementioned effects. Unless being described as absolute necessities in this specification, these technical features may be deleted, where appropriate. This disclosure may be realized in the following aspects, for example.

(1) According to one aspect of this disclosure, a fuel cell system provided. The fuel cell system includes: a fuel cell having an anode supply port and an anode discharge port; an anode supply pipe connected to the anode supply port; a fuel gas supplier arranged at the anode supply pipe, the fuel gas supplier configured to adjust a supply quantity of a fuel gas to he supplied to the fuel cell; an anode circulation pipe connected to the anode discharge port and a position at the anode supply pipe, the position at the anode supply pipe arranged between the fuel gas supplier and the anode supply port; a pressure sensor configured to detect an internal pressure in the anode supply pipe between the fuel gas supplier and the anode supply port; a circulation pump arranged at the anode circulation pipe; and a controller configured to control the circulation pump. In a condition where the internal pressure in the anode supply pipe meets a value equal to or greater than a predetermined first pressure value and/or a condition where a variation of the internal pressure meets a value equal to or greater than a predetermined first variation, the controller may control the circulation pump to feed the fuel gas from the anode supply pipe toward the anode discharge port.

The fuel cell system of this aspect achieves reduction in the internal pressure in the anode supply pipe without providing a relief valve. This makes it possible to suppress increase in the internal pressure in the anode supply pipe in order to prevent damage on each part of the fuel cell system without causing increase in a parts count in the fuel cell system.

(2) In the fuel cell system according to the foregoing aspect, the controller may further adjust the rotation quantity of the circulation pump corresponding to the internal pressure value or the variation of the internal pressure in the controlling the circulation pump to feed the fuel gas from the anode supply pipe toward the anode discharge port.

The fuel cell system of this aspect achieves reduction in power consumption at the circulation pump to allow the internal pressure in the anode supply pipe to be reduced efficiently.

(3) The fuel cell system according to the foregoing aspect may further include: an anode discharge pipe configured to discharge the fuel gas to the atmosphere, the anode discharge pipe having one end, the one end of the anode discharge pipe connected to a position at the anode circulation pipe, the position at the anode circulation pipe arranged between the circulation pump and the anode discharge port; and an exhaust valve arranged at the anode discharge pipe, the exhaust valve controlled to be opened and closed by the controller. The controller may control the exhaust valve open when at least one of a first condition, a second condition, a third condition, and a fourth condition is fulfilled, the first condition defining that the internal pressure shows a value equal to or greater than a second pressure value, the second pressure is greater than the first pressure value, the second condition defining that the internal pressure shows a value equal to or greater than the first pressure value at a point in time when a predetermined period of time has passed since the internal pressure showed a value equal to or greater than the first pressure value, the third condition defining that the internal pressure increases again to show a value equal to or greater than the first pressure value after the internal pressure decreases to under the first pressure value, the fourth condition defining that the variation of the internal pressure shows a value equal to or greater than a second variation, the second variation is greater than the first variation.

The fuel cell system of this aspect makes it possible to reduce or prevent unnecessary discharge of an anode gas.

(4) The fuel cell system according to the foregoing aspect may further include: a cathode gas supplier configured to supply air to the fuel cell; and a cathode discharge pipe including a discharge gas discharge port, the discharge gas discharge port configured to discharge a discharge gas containing the air to the atmosphere, the discharge gas discharge port connected to a cathode discharge port of the fuel cell. The anode discharge pipe may have the other end, the other end of the anode discharge pipe connected to a position at the cathode discharge pipe, the position at the cathode discharge pipe is between the cathode discharge port and the discharge gas discharge port. When at least one of the first condition, the second condition, the third condition, and the fourth condition is fulfilled, the controller may control the cathode gas supplier to increase the supply quantity of the air to an amount greater than an amount during normal operation of the cathode gas supplier.

The fuel cell system of this aspect makes it possible to reduce or prevent discharge of the anode gas of a high concentration to the outside from the fuel cell system.

This disclosure is feasible in various aspects other than those described above. These aspects include a method of controlling a fuel cell system, a vehicle on which a fuel cell system is mounted, a method of controlling a circulation pump, a method of reducing an internal pressure in an anode supply pipe, a computer program for realizing these methods, and a storage medium storing such a computer program, for example.

What is claimed is:

1. A fuel cell system comprising:
a fuel cell having an anode supply port and an anode discharge port;
an anode supply pipe connected to the anode supply port;
a fuel gas supplier arranged at the anode supply pipe, the fuel gas supplier configured to adjust a supply quantity of a fuel gas to be supplied to the fuel cell;
an anode circulation pipe connected to the anode discharge port and a position at the anode supply pipe, the position at the anode supply pipe arranged between the fuel gas supplier and the anode supply port;
a pressure sensor configured to detect an internal pressure in the anode supply pipe between the fuel gas supplier and the anode supply port;
a circulation pump arranged at the anode circulation pipe; and
a controller configured to control the circulation pump, wherein
in a condition where the internal pressure in the anode supply pipe meets a value equal to or greater than a predetermined first pressure value and/or a condition where a variation of the internal pressure meets a value equal to or greater than a predetermined first variation, the controller controls the circulation pump to feed the fuel gas from the anode supply pipe toward the anode discharge port.

2. The fuel cell system according to claim 1, wherein
the controller further adjusts the rotation quantity of the circulation pump corresponding to the internal pressure value or the variation of the internal pressure in the controlling the circulation pump to feed the fuel gas from the anode supply pipe toward the anode discharge port.

3. The fuel cell system according to claim 1, further comprising:
an anode discharge pipe configured to discharge the fuel gas to the atmosphere, the anode discharge pipe having one end, the one end of the anode discharge pipe connected to a position at the anode circulation pipe, the position at the anode circulation pipe arranged between the circulation pump and the anode discharge port; and
an exhaust valve arranged at the anode discharge pipe, the exhaust valve controlled to be opened and closed by the controller, wherein
the controller controls the exhaust valve open when at least one of a first condition, a second condition, a third condition, and a fourth condition is fulfilled, the first condition defining that the internal pressure shows a value equal to or greater than a second pressure value, the second pressure is greater than the first pressure value, the second condition defining that the internal pressure shows a value equal to or greater than the first pressure value at a point in time when a predetermined period of time has passed since the internal pressure showed a value equal to or greater than the first pressure value, the third condition defining that the internal pressure increases again to show a value equal to or greater than the first pressure value after the internal pressure decreases to under the first pressure value, the fourth condition defining that the variation of the internal pressure shows a value equal to or greater than a second variation, the second variation is greater than the first variation.

4. The fuel cell system according to claim 3, further comprising:
a cathode gas supplier configured to supply air to the fuel cell; and
a cathode discharge pipe including a discharge gas discharge port, the discharge gas discharge port configured to discharge a discharge gas containing the air to the atmosphere, the discharge gas discharge port connected to a cathode discharge port of the fuel cell, wherein
the anode discharge pipe has the other end, the other end of the anode discharge pipe connected to a position at the cathode discharge pipe, the position at the cathode discharge pipe is between the cathode discharge port and the discharge gas discharge port, and
when at least one of the first condition, the second condition, the third condition, and the fourth condition is fulfilled, the controller controls the cathode gas supplier to increase the supply quantity of the air to an amount greater than an amount during normal operation of the cathode gas supplier.

5. A method of controlling a fuel cell system comprising:
acquiring an internal pressure in an anode supply pipe from a pressure sensor, the anode supply pipe connected to an anode supply port of a fuel cell; and
when a condition where the internal pressure meets a value equal to or greater than a predetermined first pressure value and/or a condition where a variation of the internal pressure meets a value equal to or greater than a predetermined first variation is fulfilled, feeding an anode gas in an anode circulation pipe in a direction from the anode supply pipe toward an anode discharge port of the fuel cell by controlling a circulation pump, the anode circulation pipe connecting the anode discharge port and the anode supply pipe.
